(19) United States
(12) Patent Application Publication
(10) Pub. No.: US 2025/0060204 A1
(43) Pub. Date: Feb. 20, 2025

(54) BENT TUBE MEASUREMENT USING A VIRTUAL SHARP

(71) Applicant: ULTRA CLEAN HOLDINGS, INC., Hayward, CA (US)

(72) Inventor: Jeffrey NELSON, Round Rock, TX (US)

(21) Appl. No.: 18/801,182

(22) Filed: Aug. 12, 2024

Related U.S. Application Data
(60) Provisional application No. 63/520,021, filed on Aug. 16, 2023.

(51) Int. Cl. G01B 3/30

(52) U.S. Cl. CPC G01B 3/30

(57) ABSTRACT

An apparatus for determining the location of features in a bent element having at least two straight portions and at least one bend between the two straight portions includes a first rail, a second rail, a third rail, a first rotary coupling rotationally coupling the first rail to the second rail and operatively coupling to a first rotary encoder, a second rotary coupling rotationally coupling the second rail to the third rail and operatively coupling to a second rotary encoder, and a linear encoder configured and arranged to determine the location of the second rotary coupling on the second rail.

### CROSS-REFERENCE TO RELATED APPLICATIONS

This application claims benefit of U.S. provisional patent application Ser. No. 63/520,021, filed Aug. 16, 2023, which is herein incorporated by reference.

### BACKGROUND OF THE DISCLOSURE

### Field of the Disclosure

The present disclosure relates to the field of fluid communication, more specifically to the fabrication of fluid circuits using tubing, and still more specifically to the repeatable fabrication of bent tubing, and the measurement, inspection, and documenting of the bends and lengths of the tubing.

### Description of the Related Art

Tubings are used to allow fluid tight, from the exterior thereof, flows of fluids from a source location to a destination location. Herein, the tubings are discussed with respect to the use of the tubing in an enclosure, but the methods and apparati discussed herein are applicable to the precision fabrication of rigid bent tubing for any applications. The tubings may be incorporated into an enclosure, which provides a contained environment for the tubings. For example, one such enclosure is a gas panel, which is a term in the art of semiconductor fabrication equipment, within which, on the exterior of which, or both, tubings are connected to allow contained fluid flow from a gas source to a desired destination for that gas. A desired destination would be, for example, a semiconductor processing chamber using one or more gases to process a substrate therein. A single gas panel commonly includes a plurality of leak tight fluid circuits therein, which include components such as mass flow controllers or other components configured to controllably flow fluids therethrough, valves for switching the flow of gas to or through the flow control components, flow meters configured to measure the flow of gas though an individual flow line, and other components such as fittings for connection of a tubing to a gas panel component, heaters, chillers, and the like. Additionally, different fluids may flow through different ones of the flow control circuits in the gas panel. These fluids may be toxic, corrosive, flammable or explosive if exposed to the local ambient environment, in other words, to air.

Commonly the rigid tubings have connectors or fittings affixed to the opposed ends thereof for connection to the fluid source, to the fluid use location, or interconnections to additional components, such as additional tubing(s), therebetween. The connectors on the tubing ends are connectable to mating connectors, either on another tubing, a flow component, or on or in a gas panel.

The enclosure is a volume in three-dimensional space, within which connection locations for the tubings are provided. To fit multiple independent fluid flow paths through a single enclosure while minimizing the size of the enclosure, the location of the centerline of a fluid inlet connector to connect to an inlet connector on the fluid inlet end of a tubing is often not collinearly aligned with the centerline of a fluid outlet connector provided to connect to a fluid outlet connector on the outlet end of a connector on a tubing. Additionally, to fit all of the tubings required within the enclosure, the fluid connection design may require tubings be bent in two dimensions, for example in the x and y directions of a Cartesian coordinate system, or in three dimensions, for example the x, y and z directions of Cartesian coordinate system. Thus to interconnect two different connections in the enclosure with rigid tubing, lengths of rigid tubing are commonly bent, to align the inlet connector connected at the inlet end thereof with a gas source connector location within the enclosure, and the gas outlet connector at the gas outlet end thereof with the location of the desired outlet connector of the enclosure therefor. The lengths of the tubing between the bends, between a bend and an adjacent end of the tubing, and the angles of the bends are specified by the enclosure designer. However, the inspection of the bent tubings is problematic, as the actual location of a bend in the tubing and its radius are not easily measured using rigid tools, for example a tape measure, ruler, etc. Thus, a comparator having a moving support table to hold the bent tubing, a camera or optical imaging system to image the tubing on the table, and a mechanism for measuring the travel of the table as the tubing is scanned under the imaging system to determine the location of the beginning and ends of each bend, and the corresponding length of the straight lengths of the tubing extending from the bends. This is both time consuming and expensive, and thus not acceptable in a high volume production environment.

As shown in FIG. 1, a length of tubing 10 is shown having a single bend 12 therein. Thus, the tubing is composed of a first straight (unbent) length 14 extending from a first open end 18 thereof, a second straight (unbent) length 16 extending from a second open end 20 thereof, and a curved (bent) portion 22 of the tubing 10 fluidly interconnecting the end of the first length 14 distal of the first open end 18 and the end of the second length 16 distal to the second open end 20. Here, as the tubing 10 includes only a single bend 22, it can be considered to extend in two dimensions, for example the x and y directions. Because the tubing 10 is rigid, the bend 22 therein must extend along a radius R about a center point C, and typically, because of the physical limits of the material of the tubing to deform, that center point C is not located within the envelope of the tubing 10, in other words, the center of the bend 22 is spaced outwardly of the outer surface of the tubing 10. Here, the radius of the surface of the tubing 10 furthest from the center point C of the bend 22, in other words, the outer bent surface, is denoted Rₒ, the radius of the inner surface of the bend in the tubing or the surface closest to the center point C of the bend is denoted Rᵢ, and the radius of the centerline extending along the interior of the bend in the tubing is denoted Rₘ. As a general approximation, Rₘ=Rᵢ+ (Rₒ−Rᵢ)/2 Additionally, the intersection of the projection of the centerline CL₁ of the first length 14 through the curved portion 12 and the centerline CL₂ of the second length 16 through the curved portion 12 intersect at a point VS_{c} is likewise not overlying any portion of the length of tubing 10, and is on the opposed side of the bent portion (bend 22) from the center C of the curve the curved portion 22 extends along. This (point VS_{c}) is the virtual meeting point, or virtual sharp, of the intersection of the centerlines of the straight first and second lengths 14, 16 of the bent tubing 10. A second virtual sharp VSₒ is a point location where extension lines extending along and from the outer surface of the first and second lengths 14, 16 of the bent tubing furthest from the center point C about which the curved portion 22 extends intersect. A third virtual sharp VSᵢ is a point location where extension lines extending along and from the inner, center point C facing surface of the first and second lengths 14, 16 of the bent tubing intersect.

The specification of, i.e., of the dimensions of the lengths of the straight sections of the tubings, and the dimensions are angle of the curved sections of the tubings, is problematic. This is a result of a number of factors, including the proper measurement of the lengths of the straight portions of the tubing, in particular determining when a straight portion ends and the curved portion begins. Referring again to FIG. 1, here the location where the first length 14 of the tubing 10 meets the curved section thereof is shown as where the radius 26 from the center C passes across the tubing 10, and the location where the second length 16 of the tubing 10 meets the curved section is shown as where the radius 28 from the center C passes across the tubing 10, these radii being disposed a number of degrees apart about angle 24 about center C. However, in an actual length of bent tubing, it is often difficult, using simple eyesight or rigid tooling, to determine where curve of the curved portion 22 ends and the length of the straight first and second lengths 12, 14 end.

If the length Li of the first length 14 of tubing 10 extending between first (open) end 18 and radius 26 is too long or too short, the second (open) end 20 of the second length 16 will not be properly aligned with the destination location to which it will be connected. Likewise, if the second length 16 of tubing 10 between the second (open) end 20 and radius 28 is too long or too short, the first (open) end 18 of the first length 14 will not be properly aligned with the destination location to which it will be connected.

### SUMMARY OF THE DISCLOSURE

In one aspect, there is provided herein an inspection or measurement device configured to rapidly measure the bend angle(s), and the lengths of the straight portions, of bent tubing in a repeatable manner. The device includes at least two straight portions and at least one bend between the two straight portions includes a first rail, a second rail, a third rail, a first rotary coupling rotationally coupling the first rail to the second rail and operatively coupling to a first rotary encoder, a second rotary coupling rotationally coupling the second rail to the third rail and operatively coupling to a second rotary////encoder, and a linear encoder configured and arranged to determine the location of the second rotary coupling on the second rail.

In another aspect, the location of the virtual sharp and the length of at least one straight length of bent tubing is determined by placing a length of straight tubing against a first engagement surface of a first rail, and a second length of bent tubing against an engagement surface of a second rail pivotably connected to the first rail, while actuating the second or first rail, or both, with respect to a pivot point to bring the surface of the first length of tubing against the first face of the first rail and the surface of the second length of tubing into contact with the second face of the second rail. A third length of straight tubing, extending from a second bend in the tubing between the second length and the third length may be brought into contact with a third face of a third rail, by moving the second rails pivotably with respect to one another. The third rail may also move along the length direction of the second rail. A first rotary decoder is used to determine the angle between the first rail in contact with the first length of tubing and the second rail in contact with the second length of straight tubing, and thereby determine the angle therebetween. A projection of the plane of the first engagement surface and the second engagement surface intersect at a virtual sharp location. Using the bend angle and the specified angle of curvature of the curved portion, the locations and orientations in space of open ends of the tubing can be determined using a programmable device running algebraic and geometric calculations, to determine whether the bent tubing meets a desired design specification thereof.

In another aspect, a method of evaluating dimensions of a rigid bent tube includes providing a first rail having a first surface, providing a second rail having a second surface, providing a third rail having a third surface, providing a first rotary coupling rotationally coupling the first rail to the second rail and operatively coupling to a first rotary encoder, providing a second rotary coupling rotationally coupling the second rail to the third rail and operatively coupling to a second rotary encoder, providing a linear encoder configured and arranged to determine the location of the second rotary coupling on the second rail, positioning a first straight portion of a bent tubing against a first surface of the first rail, positioning a second straight portion of a bent tubing against a second surface of the second rail, wherein the first and second straight portions are interconnected at a bend, and measuring the angle between the first rail and the second rail using the first rotary encoder.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a plan view of a length of bent tubing, having two straight sections connected at a single bend;

FIG. 2 is an isometric view of an measuring and inspection device hereof;

FIG. 3 is a plan view of the measuring and inspection device with a length of bent tubing being evaluated in a first tubing to measuring and inspection device configuration;

FIG. 4 shows a portion of the measuring of the location of a virtual sharp from the end of a straight length of tubing;

FIG. 5 is a plan view of the measuring and inspection device with a length of bent tubing being evaluated in a second tubing to measuring and inspection device configuration;

FIG. 6 is a sectional view of a second rotary encoder and a linear encoder connection located between two rails of the measuring and inspection device;

FIG. 7 is a sectional view of a first rotary encoder connection between two rails of the measuring and inspection device; and

FIG. 8 is a schematic of a computer connected to the measuring and inspection device hereof.

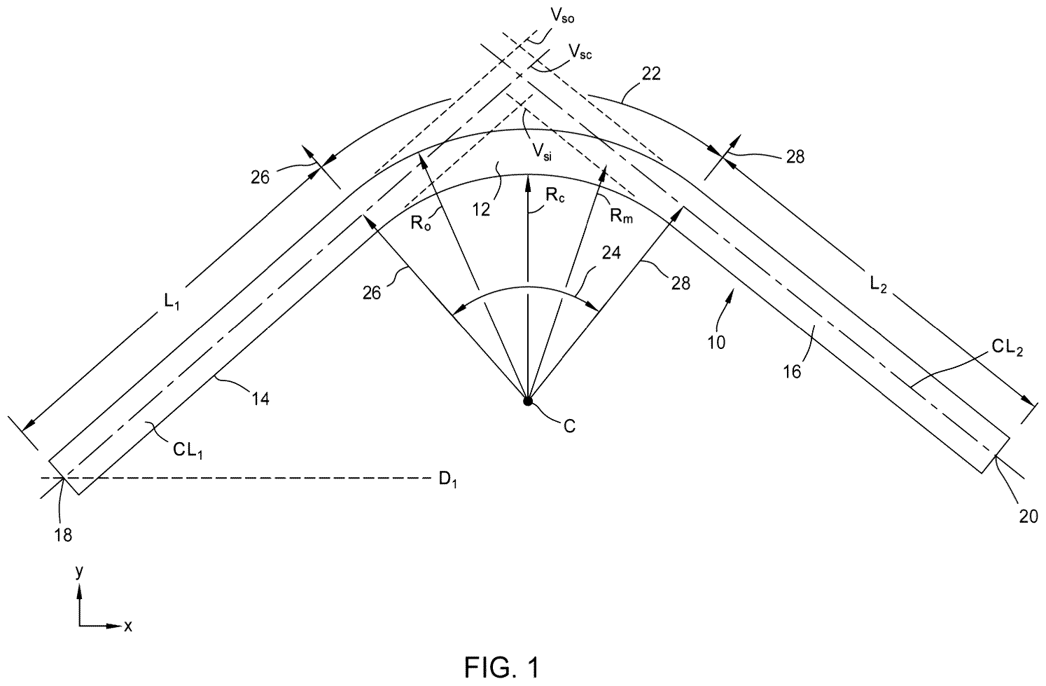

### DETAILED DESCRIPTION

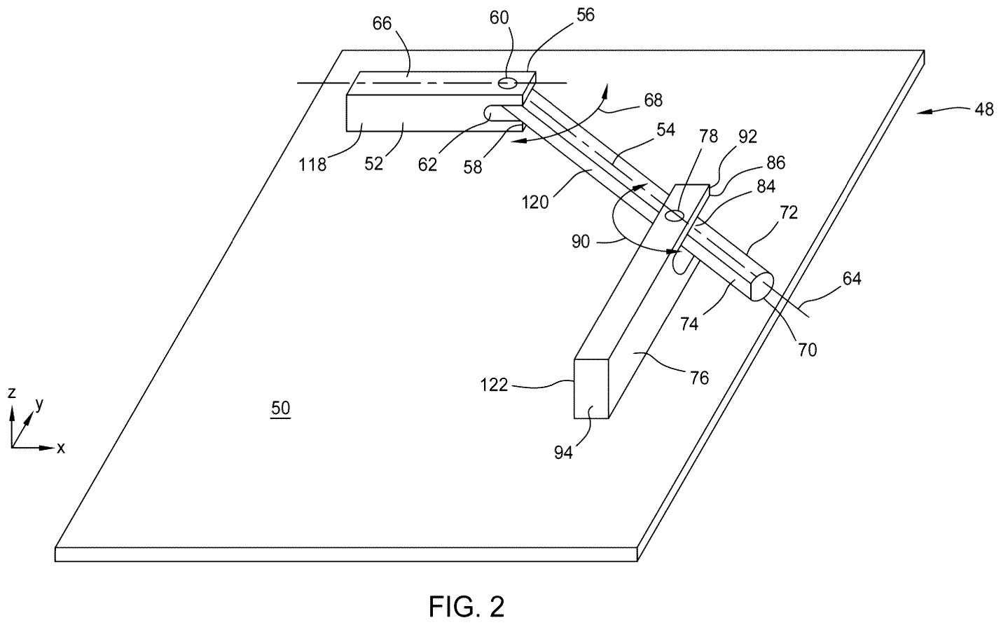

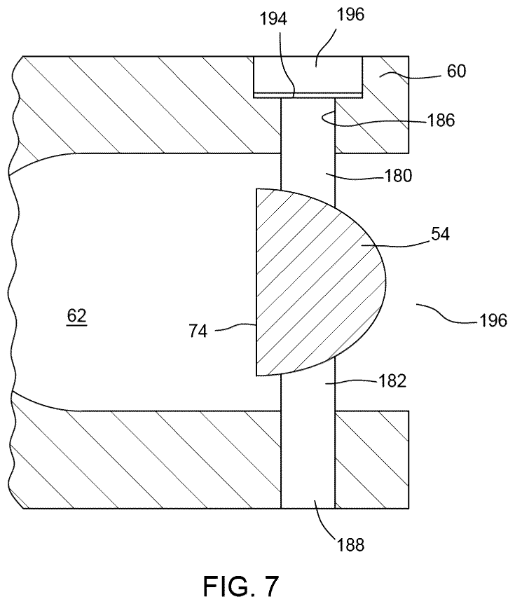

Referring to FIG. 2, there is shown a schematic isometric view of an inspection and measuring device 48 hereof. Here, the measuring and inspection device 48 includes a base 50, on which is mounted a first rail 52 which is affixed to the base 50 such as by a plurality of threaded fasteners extending through openings in the first rail 52 and inwardly of mating threaded holes in the base 50. A second rail 54 is here, at a first end 56 thereof, rotationally connected to the first rail 52 at a coupling end 58 thereof, which coupling here includes a first rotary encoder 196 (FIG. 7). Second rail 54 is freely slidable over and along the upper surface of the base 50. First rotary encoder 196 is configured to detect the angular position of the second rail 54 with respect to the first rail 52. Here, the coupling end 58 to the second rail end of the first rail 52 includes a first cutout 62 extending inwardly of the coupling end 58 thereof, which allows the second rail 54 to be positioned relative to the first rail 52 such that the centerline 64 of the second rail 54 in the x-y direction of FIG. 2 and the and the centerline 66 of the first rail 52 in the x-y direction of FIG. 2 can be positioned in parallel with each other, and within limits of the tolerance of the parts, extend collinearly. The second rail 54 is also moveable along an arc 68 centered at the first rotational coupling 60 to a position where the centerlines 64, 66 of the first rails 52 and the second rail 54 intersect at an angle as great as, or even greater than, ninety degrees.

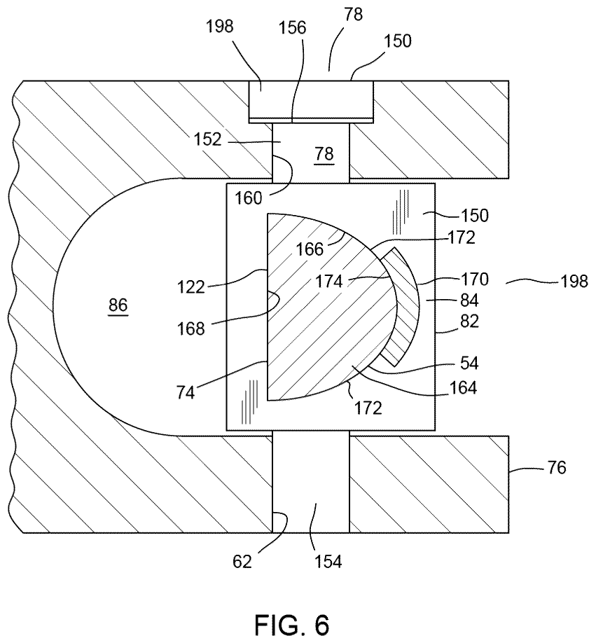

Here, second rail 54 is configured as a rod or as a rod like element having a circular or partially circular cross section in the z-x plane, having the first end 56 thereof, an opposed second end 70, and an outer circumferential surface 72. Here, for example, the rod like element forming the second rail 54 has, in cross section, a truncated circular shape having a flat 74 (FIG. 6) extending along one side thereof. Flat 74 provides a generally planar surface against which the side of a straight length of tubing can be abutted, and thus a reference surface at the same distance from the centerline 64 of the second rail regardless of the diameter of the abutting tubing. Here, a third rail 76 is also rotationally interconnected to the second rail 54, through a second rotational coupling 78 which also serves as a portion of a second rotary encoder 198 (FIG. 6). Additionally, the second rotary coupling 198 includes an inner slide member 82 (FIG. 6) though which the second rail 54 slidingly extends. Here, inner slide member 82, in cooperation with the second rail 54, also provides a linear encoder 84 (FIG. 6). Second rail 54 is here configured to extend through a slot or second cutout 86 extending inwardly of the first end wall 92 of the third rail 76, such that the relative positions thereof can be moved through a second arc 90 centered on the second rotational coupling 78. The length of the third rail 76 is bounded by opposed first and second end walls 92, 94, and the depth of the second cutout 86 inwardly of the first end wall 92 is sized to allow the angle of intersection between the third rail centerline 96 and the centerline 64 of the second rail 54 to extend between greater than zero, to at least ninety or more degrees.

Each of the first through third rails 52, 54 and 76 include a generally flat or extending in a plane engagement surface against which the outer wall or end wall of a bent length of tubing can be positioned. Here, first rail 52 includes a generally planar first engagement surface 118, and third rail 76 includes a third engagement surface 122. Additionally, where a flat 74 is provided on the rod forming the second rail 54, the flat 74 forms the second engagement surface 120 of the second rail 54.

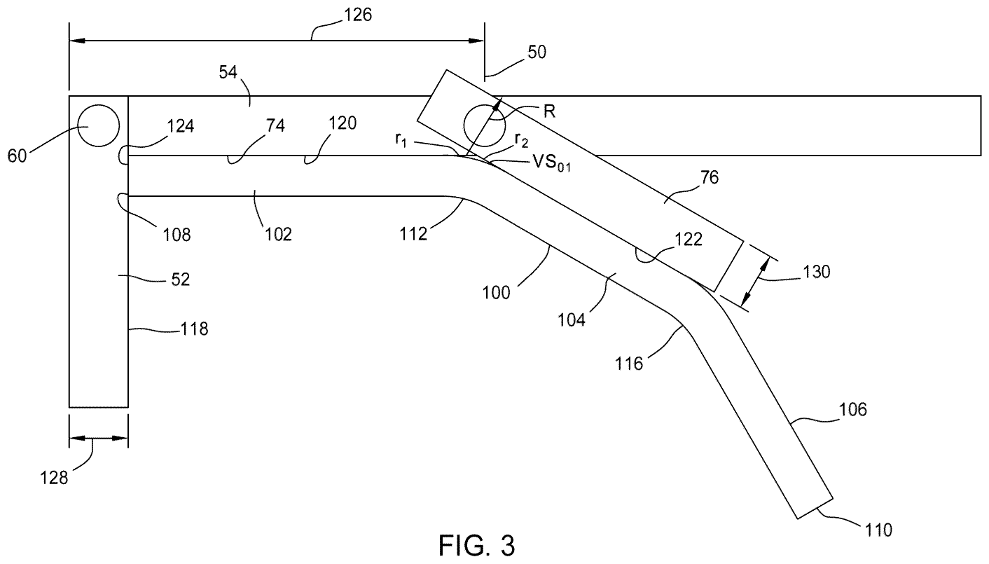

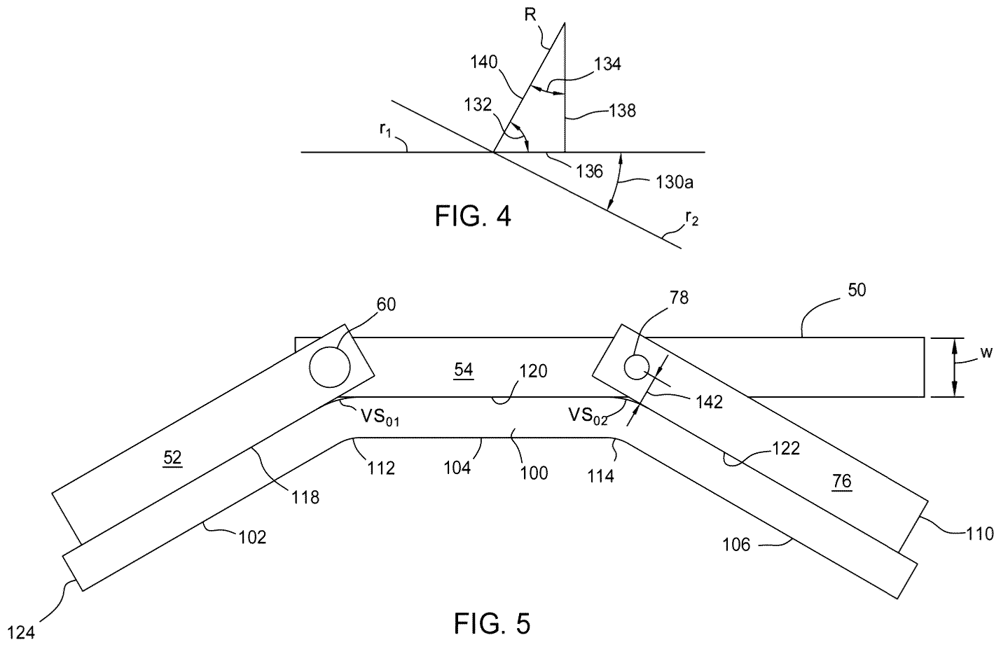

Inspection and measuring device 48 is useful to measure the bending angles and lengths of the straight sections of a length of tubing, in particular bent rigid tubing. For example, as shown in FIGS. 3 and 4, the inspection and measuring device 48 is employed to measure the angles and virtual sharp locations in a length of bent tubing, in FIG. 3 a length of tubing having two bends and three straight length sections.

Here, the location of the virtual sharp can be used to locate the center of the bend in the length of tubing, for virtual sharps for a first bend 112 and a second bend 116 of FIG. 3, and thereby infer the locations of the centerline of the tubing in the straight or unbent portions thereof.

In FIG. 3, the inspection and measuring device 48 is shown in use to identify the location of a first virtual sharp VSₒ₁ adjacent to the outer wall of the bent tubing 100, here adjacent to the first bend 112 of the bent tubing 100 located between a first straight length 102 section and second straight length 104 section thereof. In this example, the bent tubing 100 includes two bends, the first bend 112 between a first straight length 102 of a bent tubing 100 and a second straight length section 104 of the bent tubing 100, and a second bend 116 between the second straight length section 112 and the third straight length section 116 of the bent tubing 100. Here, the outer surface of the bent tubing 100 contacting the second and third engagement surfaces 120, 122 and the circumferential wall 124 of the first open end 108 of the bent tubing 100 are used as reference locations on the bent tubing 100. To determine the distance from the flat first open end 108 of the bent tubing 100 and the virtual sharp VSₒ₁, and the angle between the centerlines of the first and second straight lengths 102, 104 of bent tubing 100, the flat open end 108 of the tubing is contacted against the first engagement surface 118 of the first rail 52 while the outer circumferential surface of the first straight length 102 of the tubing 100 between the first bend 112 and the first open end 108 facing the flat 74 forming the second engagement surface 120 of the second rail 54 are pulled or pushed together. Then, the third rail 76 is slid in the direction of the first rotational coupling 60, until the third engagement surface 122 thereof is parallel to, and in contact with, the outer surface of the second straight length 104 of the tubing 100 extending between the first and second bends 112, 116. The linear encoder 84 (FIG. 6) provides a signal indicative of the location of the second rotational coupling 78 on the second rail 54, and the second rotary encoder 198 generates a signal corresponding to the angle between the second rail 54 and the third rail 76. The signal from the linear decoder 84 indicates the distance 126 between the first end 56 of the second rail 54 and the center of the second rotary coupling 78, and the signal from the second rotary encoder 198 indicates the angle between the second and third rails 54, 76. As the first open end 108 of the tubing 100 is at a right angle to the outer wall thereof, and the circumference of the surface of the first open end 108 of the tubing 100 abuts and contacts the first engagement surface 118 of the first rail 52 while the outer surface of the first straight length 102 of the tubing 100 contacts the second engagement surface 120 of the second rail 54 over the length of the first straight length 102 section, the angle between the first and second rails 52, 54 is ninety degrees, so long as the end face of the first straight length 102 of tubing 100 is perpendicular to the centerline of the first straight length 102 of tubing 100. Thus, the location in free space of the first open end 108 of the tubing is the location of the first end of the second rail less (minus) the width 128 of the first rail 52. The location of the first virtual sharp VS01 is at the location of the intersection of a ray R, extending one-half way between a ray r₁ parallel to the second engagement surface 120 of the second rail 54 and a ray r₂ parallel to the third engagement surface 122 of the third rail 76. As the second rotational coupling 78 is centered in the width 130 direction of the third rail 76, the location of the virtual sharp VS01 is one-half the width 130 of the second rail from the center of the second rotational coupling 78 along the ray R. Thus, the distance between the first open end 108 of the tubing 100 and the virtual sharp VSo1 is:

The distance between the center of the second rotary encoder overlying the second rail 54 and the end thereof connected to the first rail 52 (the center of a first rotary encoder 196), here distance 126;

Less (minus) one half of the width 128 of the first rail 52 (the distance from the center of the first rotary encoder 196 to the first engagement surface 118);

Less the length l of line segment 136 (FIG. 4), which is the length between an imaginary line 138 intersecting the center of the second rotary coupling and normal to the a line segment extending, in FIG. 5, to the right hand side of the virtual sharp VSo1 from the second engagement surface 120 where that imaginary line 138 crosses over or intersects the line segment extending from the second engagement surface 120, and the location of the virtual sharp VSo1. Here, ray 140 extends from the virtual sharp VSo1 to the center of the second rotational coupling 78. The angle 134 between the ray 140 and the imaginary line 138 is the value of 90 degrees less (minus) the value of the angle 130a, which also corresponds to the bend angle.

Therefore, the length of the line segment 136 is equal to:

I=W tan β,

where W is the length of the imaginary line 138 which is the distance between the centerline of the second rail 54 and the flat 74, B is the angle 134 which is 90 degrees less (minus) measured bend angle 130a between the first and second rails 52, 54, and I is the distance between the location where the imaginary line 138 passes over or intersects the second engagement surface 120 and the first virtual sharp VSo1. Here, ray 140 has a length equal to one-half the Thus, using the inspection and measuring device 48, a mechanism for accurately determining the relative position of the ends of the tubing with respect to the bend angles, and the thus the lengths of the straight length sections or segments thereof, can be determined.

Referring now to FIG. 5, the measurement and inspection device is also useful to evaluate a segment of a straight length of tubing between two bends in the tubing. Here, a span of the first straight length 102 of tubing 100 is located against the first engagement surface 118 of the first rail 52, and the second rail 54 is moved arcuately so that the second engagement surface 120 thereof abuts the entire length of the outer side of the second straight length 104 of the tubing 100, where the first bend 112 is positioned with the minimum possible gap between the outer side wall of the tubing and the adjacent intersection of the first and second engagement surfaces 118, 120. The third rail 76 is then moved linearly along the second rail 54 and swung about the second rotational coupling 78 to abut a span of the third straight length 106 of the tubing 100 thereagainst as shown in FIG. 5.

The location of the first virtual sharp VS01 is then determined algebraically as discussed above based on the measured first bend angle and the span between the center of the first rotational coupling 60 and the first engagement surface 118, as the first virtual sharp VSo1 is located where the projections of the first and second engagement surfaces 118, 120 overlap. The distance between the first virtual sharp VSo1 of the first bend 112 and the second virtual sharp VSo2 of the second bend 116 is then determined using the signal from the liner decoder indicative of the distance between the end of the second rail 54 and the second rotational coupling 78, the second bend angle based on the signal of the second rotary decoder 198, and the distance between the center of the second rotational coupling 78 and the third engagement surface 122 of the third rail 76.

The distance between the second virtual sharp VS02 and the second open end 110 of the tubing can be determined using the inspection and measuring device 48 in the same manner shown in FIG. 3, here by abutting the second open end 110 against the first engagement surface 118 and the outer wall of the third straight length 106 of the tubing 100 against the second engagement surface 120, and the outer surface of the first straight length 102 of tubing against the third engagement surface 122.

Using the system of measurement described herein, a fast, repeatable and accurate evaluation of the dimensional correctness of a bent tubing can be made. In contrast to methods of inspection that attempt to judge the length of the straight sections of the tubing by judging where a straight portion ends and a curve begins, here, the virtual sharp is used as the reference point for the bends. This results in more accurate and repeatable evaluation of bent tubing. The locations of each virtual sharp VS₀ is the location where a projection of the outer surfaces of the two straight lengths of tubing to either side of a bend intersect. Thus, for a given bent tubing layout or design, it is readily calculable if not already present on a drawing of the bent tubing.

Referring now to FIG. 6, the pivoting and sliding connection of the second rail 54 with the third rail is shown. Here, the third rail 54 is shown partially, and in section, to show the connection of the second rotational coupling 78 with the third rail and with a slide block 150, and the connection of the second rail 54 through the slide member. Here, the second rotational coupling 78 is configured to include a first shaft 152, a second shaft 154, and a slide block 150 affixed therebetween. The first shaft 152 is rotatably supported in a first bore 160 in the third rail 76, and the second shaft 154 is rotatably supported in a second bore 162 in the third rail 76. The first shaft 152 is configured to cooperate with a second rotary encoder 198 which extends over the upper end 156 of the first shaft 152 of the rotational coupling 78. For example, the upper end 156 of the first shaft 152 may include an optical gray pattern, and the second rotary encoder 198 includes an illumination device and a charge coupled device configured to receive a reflected signal from the gray pattern indicative of the rotational position of the first shaft 152 with respect to the second rotary encoder 198.

The slide block 150 includes a through slide opening 164 extending therethrough, having the form of a truncated circle in section. The center of a the circular portion of the opening, i.e., the center of a circle which runs along the curved inner wall 166 of the slide opening 164 lies upon a center line passing through the centers of the first and second shafts 152, 154. A flat portion 168 extends generally parallel to the centerline passing through the centers of the first and second shafts 152, 154. The cross section of the slide opening 164 is configured to mimic the outer circumferential profile of the second rail 54, with a slight clearance between the outer surface of the second rail 54 and the inner surface of the slide opening 164, which allows the slide block 150 to slide over the second rail 54 or vide-versa. The flat portion 168 is located to serve as a key to properly orient the position of the flat 74 of the second rail 54 to face a section of tubing when the inspection and measuring device 48 is employed to evaluate a bent tubing. The mating contours of the second rail 54 and the through slide opening 164, including the flat 74 and flat portion 168, prevent rotation of the second rail 54 about its longitudinal axis.

The slide block 150 includes a linear encoding device 170 providing the linear encoder 84, having a reading side 174 facing the curved outer surface 172 of the second rail 54. The linear encoding device 170 encoding device and the curved outer surface 172 together cooperate as a linear encoder, such that sliding motion of the second rail 54 (inwardly or outwardly of the page of the Figure) results in the generation of a signal representative of the span of the linear motion of the second rail 54 within the slide block 150. Similarly, to the second rotary encoder 198, the linear encoding device 170 can include an illumination device and a camera, and the facing portion of the outer curved surface 172 of the second rail 54 can include a series of spaced markings along it length direction. The illumination device illuminates the facing portion of the outer curved surface 172, and the camera detects the markings and the movement of them past the camera as the second rail 54 moves within the slide block 150.

Referring now to FIG. 7, the rotational connection of the first rail 52 to the second rail 54 is shown. Here, the first rail 54 is shown partially, and in section, to show the connection of the first rotational coupling 60 with the second rail 54. Here, the first rotational coupling 60 is configured to include an upper shaft 180 and a lower shaft 182. The upper shaft 180 is rotationally supported in an upper bore 186 in the first rail 52, and the lower shaft 182 is rotationally supported in a lower bore 188 in the first rail 52. The ends of the upper and lower shafts 180, 182 projecting inwardly of the first cutout 62 of the first rail 52 connect to opposed sides of the second rail 54 forming the upper and lower bounds of the first cutout 62. The upper shaft 180 is configured to cooperate with the first rotary encoder 196 that extends over the upper shaft end 194 of the upper shaft 180 of the first rotational coupling 60. For example, the upper shaft end 194 of the upper shaft 180 may include an optical gray pattern, and the first rotary encoder 196 includes an illumination device and a charge coupled device configured to receive a reflected signal from the gray pattern indicative of the rotational position of the upper shaft 180 with respect to the encoder. The longitudinal centerlines of the upper and lower shafts 180, 182 are collinear, and the center of a circle that lies upon the curved portion of the outer circumference of the first rail 54 also lies on an extension of these centerlines.

Here, the rotary encoder and linear encoders are preferably configured as absolute encoders, wherein a zero position is established therefor, and all outputs thereof are read as referenced back to that original zero position.

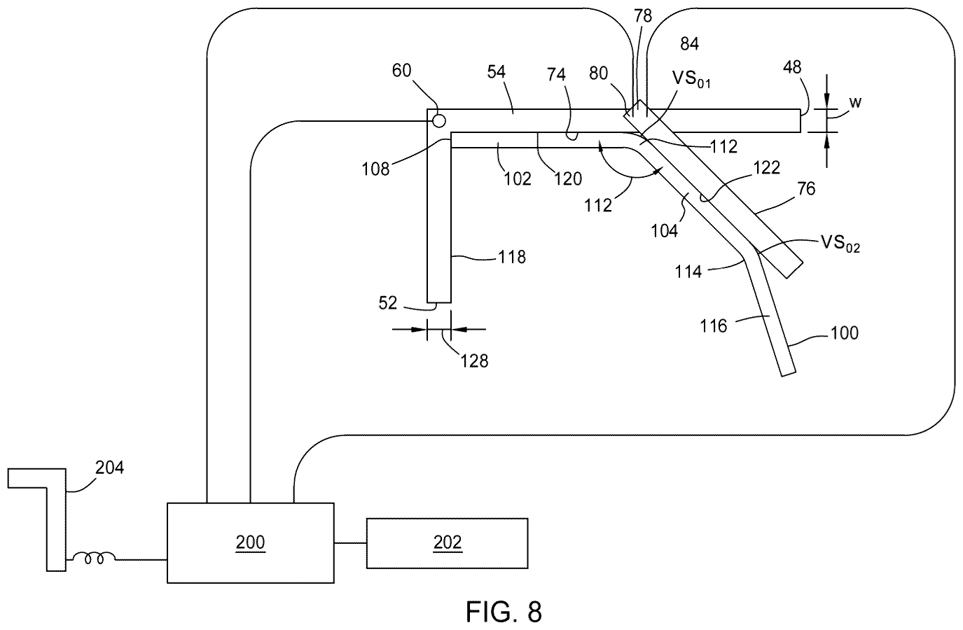

Referring to FIG. 8, a schematic of the connections of the inspection and measuring device 48 to an aide device are shown. Here, the aide device is a general purpose computer 200 and optionally a printer and a scanning device such as a scanner 204 capable of reading identity information, such as a bar code or RFID tag on a length of tubing, the computer connected to each of the first and second rotary encoders 196, 198 and the linear encoder 84. Each of the encoders (Linear encoder 84, first rotary encoder 196 and second rotary encoder 198) are configured to transmit a signal to the computer 200, either through hard wires or a wireless protocol, indicative of the angle between the first rail 52 and second rail 54, the angle between the second rail 54 and the third rail 76, and the relative location of the second rotational coupling 78 in the second cutout 86 of the second rail 54, which indicates the position of the third rail 76 along the length direction of the second rail 54. The computer 200 is programmed to, for a given tubing configuration, compare the virtual sharp locations and the lengths of the straight section of the tubing as measured using the methodologies described herein to reference lengths and reference virtual sharps. Thus for any tubing configuration, a user may enter the identity information manually using for example a keyboard, scan a code on the tubing, or another methodology, and the computer accesses its memory to obtain for the reference lengths and reference virtual sharps for that specific tubing configuration among multiple instances of reference data stored for multiple tubing configurations. The reference data may include a single item of data for each reference data, or a range of values. For example, if the signals from the encoders (linear encoder 84, first rotary encoder 196 and second rotary encoder 198) indicate that the actual locations of the virtual sharps are within the reference range thereof, and the actual lengths of the straight portions measured are within the reference range therefore, then the bent tubing is considered to be acceptable and can be used for its intended purpose. If any actual length or virtual sharp falls outside of its respective reference range, the bent tubing is considered defective and will not be used.

The computer 200 then stores the results of the inspection of the tubing corresponding to the identity of the tubing for tracking purposes. For example, if the tubing has a bar code thereon, the scanner 204 is employed to scan the code. The code identifies, for example, the design of the tubing configuration, and the computer 200 then uses the design information to fetch the reference data for that design. For example, the information on the bar code may include a part number, and the computer memory stores the reference data with respect to the part number. Then an operator manipulates the measurement and inspection device 48 and the length of tubing having the just scanned bar code together, as described herein, to allow the encoders (linear encoder 84, first rotary encoder 196 and second rotary encoder 198) to deliver actual data regarding the lengths of the straight length portions and the locations of the virtual sharps. The computer then compares that data to the reference data, and if the desired degree of matching, for example the actual lengths and angles, and thus virtual sharps, are within ranges specified for that tubing design, signals that the tubing is usable as that part number. The computer may also be configured to store, in its memory, or on a server connected thereto, the results of the evaluation of the specific tubing. For example, for tracing purposes, each tubing may have a unique identification, for example a numeric or alphanumeric identifier. Where a bar code is employed and affixed to the tubing, the bar code includes that identification information. That identification information can be used, by the computer, to fetch the design information for the tubing, either from its own memory or from a server. The results of the evaluation of the tubing can then be saved in memory or a server, in association with the part number.

The use of the inspection and measuring device 48 enables the fabrication of bent tubings with a high degree of accuracy and reliability. The desired lengths of the straight lengths of tubing, and the angles between adjacent straight lengths of tubing, are used to determine the location of the virtual sharps corresponding to a correctly fabricated tubing. For example, the widths of the first and third rails 52 and 76 and the distance between the flat 74 and the centerline of the second rail 54 are known. Using the equation:

I=W tan β,

where W is the length of the imaginary line 138 which is the distance between the centerline of the second rail 54 and the flat 74, β is the angle 134 which is 90 degrees less (minus) measured bend angle 130a between the first and second rails 52, 54, and I is the distance between the location where the imaginary line 138 passes over or intersects the second engagement surface 120 and the first virtual sharp VSo1. Here, ray 140 has a length equal to one-half the Thus, using the inspection and measuring device 48, a mechanism for accurately determining the relative position of the ends of the tubing with respect to the bend angles, and the thus the lengths of the straight length sections or segments thereof, can be determined. Thus, an inspection and measuring device is provided for ensuring repeatable fabrication of bent tubings.

While the foregoing is directed to embodiments of the present disclosure, other and further embodiments of the disclosure may be devised without departing from the basic scope thereof, and the scope of the invention is determined by the claims that follow.

1. An apparatus for determining the location of features in a bent element having at least two straight portions and at least one bend between the two straight portions, the apparatus comprising:
a first rail;
a second rail;
a third rail;
a first rotary coupling rotationally coupling the first rail to the second rail and operatively coupling to a first rotary encoder;
a second rotary coupling rotationally coupling the second rail to the third rail and operatively coupling to a second rotary encoder; and
a linear encoder configured and arranged to determine the location of the second rotary coupling on the second rail.

2. The apparatus of claim 1, wherein the third rail is linearly moveable with respect to the second rail.

3. The apparatus of claim 1, wherein the second rail is at least partially circular in cross section.

4. The apparatus of claim 1, wherein the second rail includes a flat forming an engagement surface to contact the outer wall of a tubing.

5. The apparatus of claim 1, wherein the first rail and the second rail are positionable to extend collinearly with one another.

6. The apparatus of claim 5, wherein the first rail includes a first end and a second end, the second end including a first cutout portion extending inwardly thereof, and the first rotary coupling extends inwardly of the first cutout portion.

7. The apparatus of claim 1, wherein the third rail includes a first end and a second end, the second end including a second cutout portion extending inwardly thereof, and the second rotary coupling extends inwardly of the second cutout portion.

8. A method of evaluating dimensions of a rigid bent tube having straight portions and bent portions, comprising;
providing a first rail having a first surface;
providing a second rail having a second surface;
providing a third rail having a third surface;
providing a first rotary coupling rotationally coupling the first rail to the second rail and operatively coupling to a first rotary encoder.
providing a second rotary coupling rotationally coupling the second rail to the third rail and operatively coupling to a second rotary encoder;
providing a linear encoder configured and arranged to determine the location of the second rotary coupling on the second rail;
positioning a first straight portion of a bent tubing against a first surface of the first rail;
positioning a second straight portion of a bent tubing against a second surface of the second rail, wherein the first and second straight portions are interconnected at a bend;
measuring the angle between the first rail and the second rail using the first rotary encoder.

9. The method of claim 8, wherein;
the first straight portion of tubing extends from the bend to a free end; and, the method further comprises;
positioning the free end of the first straight portion in contact with the first surface of the first rail;
positioning the outer circumferential surface of the first straight portion in contact with the second surface of the second rail.

10. The method of claim 9, further comprising positioning the outer circumferential surface of the second straight portion in contact with the third surface of the third rail.

11. The method of claim 10, wherein the third rail is moved relative to the second rail to position the outer circumferential surface of the second straight portion in contact with the third surface of the third rail.

12. The method of claim 11, further comprising measuring the angle between the second rail and the third rail using the second rotary encoder.

13. The method of claim 11, further comprising determining the location of the third rail on the second rail using the linear decoder.

14. The method of claim 13, further comprising providing a cutout in the end of the third rail;
positioning the linear encoder in the cutout; and
extending the second rail through the linear encoder.

15. A method of evaluating dimensions of a rigid bent tube, comprising:
providing a first rail having a first surface;
providing a second rail having a second surface;
providing a third rail having a third surface;
providing a first rotary coupling rotationally coupling the first rail to the second rail and operatively coupling to a first rotary encoder;
providing a second rotary coupling rotationally coupling the second rail to the third rail and operatively coupling to a second rotary encoder;
providing a linear encoder configured and arranged to determine the location of the second rotary coupling on the second rail; the first straight portion of tubing extends from the bend to a free end; and, the method further comprises:
positioning the free end of the first straight portion in contact with the first surface of the first rail;
positioning the outer circumferential surface of the first straight portion in contact with the second surface of the second rail.

16. The method of claim 15, wherein;
positioning a first straight portion of a bent tubing against a first surface of the first rail;
positioning a second straight portion of a bent tubing against a second surface of the second rail, wherein the first and second straight portions are interconnected at a bend;
measuring the angle between the first rail and the second rail using the first rotary encoder.

17. The method of claim 16, further comprising positioning the outer circumferential surface of the second straight portion in contact with the third surface of the third rail.

18. The method of claim 17, wherein the third rail is moved relative to the second rail to position the outer circumferential surface of the second straight portion in contact with the third surface of the third rail.

19. The method of claim 18, further comprising measuring the angle between the second rail and the third rail using the second rotary encoder.

20. The method of claim 18, further comprising determining the location of the third rail on the second rail using the linear decoder.
